(19) United States
(12) Patent Application Publication
(10) Pub. No.: US 2022/0288913 A1
(43) Pub. Date: Sep. 15, 2022

(54) ADDITIVE APPLICATION SYSTEMS AND METHODS FOR PADDED MAILERS

(71) Applicant: Georgia-Pacific Corrugated LLC, Atlanta, GA (US)

(72) Inventors: Thomas James Kernik Schrankler, Laveen, AZ (US); Jose Luis Garcia, Acworth, GA (US); Michael T. Payne, Sandy Springs, GA (US); Elisabeth Anne Shirley Walker, Marietta, GA (US)

(21) Appl. No.: 17/690,240

(22) Filed: Mar. 9, 2022

Related U.S. Application Data
(60) Provisional application No. 63/160,358, filed on Mar. 12, 2021.

(51) Int. Cl. B32B 37/12; B65D 81/03; B32B 7/14; B31B 70/62; B31B 70/74

(52) U.S. Cl. CPC B32B 37/1292; B65D 81/03; B32B 7/14; B31B 70/62; B31B 70/76; B31B 2160/106

(57) ABSTRACT

An additive application system utilized to form a padded mailer is provided, along with corresponding methods and systems. The system applies an additive liquid to a portion of a first web that, along with a second web, forms a panel of the padded mailer. After contact occurs, an internal pouch for the panel is formed. When the additive liquid and expandable adhesive positioned within the internal pouch are energized via an oven, the expandable adhesive expands in thickness within the internal pouch to form padding for the panel. Utilizing additive liquid enables use of less expandable adhesive while maintaining a desired speed of operation of the oven to still produce a desired thickness for the padding. Cooling may be applied after expansion in the oven to retain thickness expansion in the padding.

### CROSS-REFERENCE TO RELATED APPLICATION(S)

This application claims priority to U.S. Provisional Application No. 63/160,358, entitled “Additive Application Systems and Methods for Padded Mailers”, filed Mar. 12, 2021, the contents of which is hereby incorporated by reference in its entirety.

### BACKGROUND

There is an increased demand for delivery of items, such as directly to an end user's home or office. Further, increased efficiency in the logistics of performing delivery has also driven up delivery capabilities. However, there is also a desire to provide for delivery in packaging that both prevents damage to the items being delivered and is environmentally friendly.

Padded mailers are one such form of a packaging option. Some example padded mailers include two panels that attach on at least three sides to create a pocket for holding an item (e.g., document, blister pack, batteries, retail products, etc.). Some padded mailers can be formed around the item for shipping and delivery. Other example padded mailers are formed with an open pocket (such as by attaching three sides and leaving the fourth side open). Once such a padded mailer is formed, the item can be placed inside and the fourth side can be sealed—often by folding over a flap on one of the panels and sealing it to the other panel. Additional features, such as tear strips or pull-strip adhesive can be provided on the padded mailer for ease of packaging and/or opening. Some padded mailers form the paneling or other portions from plastic or other material that is non-recyclable.

Padded mailers, notably, also include padding, such as within internal pouches in one or more of the panels to provide cushioning and protection for the item inside the pocket. Unfortunately, many padded mailers are formed using plastic for the padding, such as via air cells or other technology. Such plastic, as noted above, however is typically non-recyclable.

As such, there is a desire to form more easily recyclable padded mailer. Additionally, there is a desire for improvements in the formation of such padded mailers, such as allowing for higher production speeds and utilization of less material.

### BRIEF SUMMARY

Some embodiments of the present invention form a recyclable padded mailer. In this regard, the padding of the padded mailer may be formed utilizing an expandable adhesive that allows the complete mailer to be curbside recycled (e.g., it allows the complete mailer to be introduced into the generally available curbside recycling stream). The expandable adhesive is positioned within an internal pouch of each panel between two sections of a paper-based web. Thereafter, the two panels are attached together to form the padded mailer with the pocket for the item between the two panels. The formed mailer (with the expandable adhesive in the unexpanded state) is then passed through an oven (e.g., a dryer, a heater, radiofrequency dryer, an energy exchanger, etc.) to cause the expandable adhesive within each internal pouch to expand to a desired thickness—thereby forming the padding for each panel and, thus, the padding for the overall padded mailer.

Some embodiments of the present invention seek to reduce the amount of expandable adhesive needed to form a desired thickness (and, thus, provide for reduced material costs) while still maintaining a desired production rate. Notably, the process for forming padded mailers includes aligning various operating speeds for various systems during manufacturing (e.g., transportation speeds of the various webs, operation speed of the oven, operation speed of the adhesive application systems, etc.). This is particularly true when the systems are inline with each other such that slowing the speed of one of the systems negatively affects the speed and/or effectiveness of one or more of the other systems. In this regard, it has been observed that reducing the amount of expandable adhesive within each internal pouch requires a longer time within the oven in order to cause the expandable adhesive to expand to the desired thickness for forming the padding. Increasing the amount of time being required within the oven, however, means a reduction in the operating speed of the oven and, thus, a reduction in the rate of production of the padded mailers as well as a reduction in the operating speed of various other systems (e.g., a reduction in the transportation speed of the webs).

In order to maintain the reduced amount of expandable adhesive and still maintain operation speed of the oven and other systems, some embodiments of the present invention contemplate applying additive liquid to one or more of the webs used with the expandable adhesive prior to expanding the expandable adhesive to form the padding. Notably, in some embodiments, applying additive liquid may also enable even faster operation speed of the oven and other systems in general (e.g., when using the prior “more” expandable adhesive). To explain, without being bound by theory, the expandable adhesive includes water that has polar molecules that, when energized (such as from energy of an oven), excite to cause the expansion of the expandable adhesive. With less expandable adhesive within the internal pouch of each panel, there is less water (and less polar molecules) to be excited and, thus, there is less expansion over a similar amount of time. In order to increase the efficiency of expansion of the expandable adhesive, the additive liquid includes polar molecules (such as from water) that are applied to the padded mailer. Thus, the combination of the expandable adhesive and the additive liquid result in expansion of the expandable adhesive to a desired thickness within a desired amount of time within the oven—thereby enabling efficient operation and manufacturing of the padded mailers.

In some embodiments, the additive liquid may be any liquid that includes polar molecules that are excited when energized, such as from an oven. In some embodiments, the additive liquid may include water. In some embodiments, the additive liquid may be an aqueous solution. In some embodiments, the additive liquid may include one or more non-water additives, such as salt.

Embodiments of the present invention contemplate applying the additive liquid at various application sites and/or in various manners. For example, the additive liquid may be applied before, after, and/or in conjunction with the application of the expandable adhesive to the web. In some embodiments, the additive liquid may be applied at multiple different application sites during the manufacturing process. In this regard, different additive liquids may be applied and/or vary levels or amounts of additive liquid may be applied, such as depending on the desired circumstances (e.g., type of web, type of expandable adhesive, desired thickness, desired operating speed, etc.). In some embodiments, the additive liquid may be applied to only a portion of the web, such as the internal area of a section of the web where the expandable adhesive is applied (e.g., corresponding to an internal pouch of a panel). In some embodiments, the additive liquid may be applied outside of the internal pouch. In some embodiments, the additive liquid may be sprayed onto the web, such as in mist form, dripped onto the web, or other spray application form. In some embodiments, a roller may apply the additive liquid to the web. Corresponding supplies (e.g., reservoirs) may be provided for supplying the additive liquid for the additive application system.

In some embodiments, cooling, such as via one or more cooling elements (e.g., fans, compressed air, etc.), may be applied to the expanded padded mailer to “lock-in” the expansion of the padding that occurred within the oven. In this regard, for example, prior to or in conjunction with positioning an expanded padded mailer in a stack (e.g., with other expanded padded mailers), dedicated cooling may be applied to the expanded padded mailer. In this regard, it has been observed that the level of expansion of the padding that occurred within the oven may not last (e.g., it may reduce) over time after leaving the oven, ultimately settling at a resting expansion thickness that is less than the level of expansion achieved within the oven. Applying cooling to the padded mailer after expansion occurs (and before a resting expansion thickness is achieved), however, results in less reduction of the expansion thickness to when the resting expansion thickness is achieved. Additionally, it has been observed that applying cooling decreases the amount of time needed to reach a resting expansion thickness, thereby enabling earlier positioning of the expanded padded mailer in a stack of padded mailers (since otherwise the weight of the other padded mailers thereon may crush the expanded padded mailer and reduce the expansion thickness that was previously achieved).

In an example embodiment, a system utilized in formation of a padded mailer is provided. The system comprises an additive application system for applying an additive liquid to a portion of a first web. A section of the first web that includes the portion of the first web and a section of a second web form a panel of the padded mailer. The section of the first web defines a perimeter and an internal area. The portion of the first web to which the additive liquid was applied includes the internal area of the section of the first web. The section of the second web defines a perimeter and an internal area. After the section of the first web and the section of the second web contact each other, the internal area of the section of the first web faces the internal area of the section of the second web to form an internal pouch. When the additive liquid and the expandable adhesive are energized via an oven, the expandable adhesive expands in thickness within the internal pouch to form padding for the panel of the padded mailer.

In some embodiments, the additive application system comprises at least one nozzle for spraying the additive liquid onto the portion of the first web. In some embodiments, the additive application system comprises a reservoir for holding a supply of the additive liquid, wherein the reservoir is in fluid communication with the at least one nozzle. In some embodiments, the at least one nozzle is configured to spray the additive liquid as a mist during application of the additive liquid onto the portion of the first web.

In some embodiments, the additive application system comprises a roller for contacting the portion of the first web to apply the additive liquid thereto.

In some embodiments, the additive liquid comprises water.

In some embodiments, the additive liquid is an aqueous solution.

In some embodiments, the additive liquid comprises a non-water additive.

In some embodiments, the additive application system is configured to apply an amount of additive liquid in a range of 0.001 g/in²-0.018 g/in² for the padded mailer. In some embodiments, application of the amount of additive liquid in the range of 0.001 g/in²-0.018 g/in² for the padded mailer enables (i) initial application of an amount of expandable adhesive in a range of 0.014 g/in²-0.030 g/in² for the padded mailer; and (ii) operation of one or more components of the oven at a desired speed to still cause expansion of the expandable adhesive such that a desired thickness of the padded mailer is in a range of 0.25-0.32 in.

In some embodiments, the additive application system is configured to apply the additive liquid onto the portion of the first web after the expandable adhesive has been applied to the internal area of the section of the first web or to the internal area of the section of the second web.

In some embodiments, the additive application system is configured to apply the additive liquid onto the portion of the first web before the expandable adhesive has been applied to the internal area of the section of the first web or to the internal area of the section of the second web.

In some embodiments, the additive application system is configured to apply the additive liquid onto the portion of the first web in conjunction with application of the expandable adhesive to the internal area of the section of the first web.

In some embodiments, the additive application system comprises a first application site along a web path for the first web and a second application site along the web path for the first web, wherein the second application site is downstream from the first application site along the web path. In some embodiments, the additive application system is configured to apply a first additive liquid onto the portion of the first web at the first application site; and apply a second additive liquid onto the portion of the first web at the second application site, wherein the first additive liquid comprises a different composition than the second additive liquid.

In some embodiments, the additive application system is configured to apply the additive liquid to the portion of the first web that includes the expandable adhesive.

In another example embodiment, a method is provided. The method includes applying, via an additive application system, an additive liquid to a portion of a first web. A section of the first web that includes the portion of the first web and a section of a second web form a panel of the padded mailer. The section of the first web defines a perimeter and an internal area. The portion of the first web to which the additive liquid was applied includes the internal area of the section of the first web. The section of the second web defines a perimeter and an internal area. After the section of the first web and the section of the second web contact each other, the internal area of the section of the first web faces the internal area of the section of the second web to form an internal pouch. When the additive liquid and the expandable adhesive are energized via an oven, the expandable adhesive expands in thickness within the internal pouch to form padding for the panel of the padded mailer.

In some embodiments, applying the additive liquid onto the portion of the first web occurs after the expandable adhesive has been applied to the internal area of the section of the first web or to the internal area of the section of the second web.

In some embodiments, applying the additive liquid onto the portion of the first web occurs before the expandable adhesive has been applied to the internal area of the section of the first web or to the internal area of the section of the second web.

In some embodiments, applying the additive liquid onto the portion of the first web occurs in conjunction with application of the expandable adhesive to the internal area of the section of the first web.

In yet another example embodiment, a system for forming a padded mailer is provided. The system comprises a first web management device for controlling translation of a first web along a first web path and a second web management device for controlling translation of a second web along a second web path. The system further includes a first adhesive application system for applying a first adhesive to at least a portion of a perimeter of a section of the first web that defines a bottom layer of a panel of the padded mailer. The first adhesive is configured to adhere the perimeter of the section of the first web to a perimeter of a section of the second web that defines a top layer of the panel so as to form the panel. The section of the first web further defines an internal area surrounded by the perimeter. The section of the second web further defines an internal area surrounded by the perimeter. The system further includes a second adhesive application system for applying an expandable second adhesive to the internal area of the section of the first web. The system further includes an additive application system for applying an additive liquid to at least one of the internal area of the section of the first web or the internal area of the section of the second web prior to bringing the section of the first web and the section of the second web into contact with each other. The system further includes an oven for providing energy, after the section of the first web and the section of the second web contact each other, to energize the additive liquid and the expandable second adhesive to cause the expandable second adhesive to expand in thickness to form padding for the panel of the padded mailer.

In some embodiments, the system further includes a cooling element for applying cooling to the padded mailer after the padded mailer passes through the oven so as to retain thickness expansion of the padding for the padded mailer.

In yet another example embodiment, a method of forming a padded mailer is provided. The method includes applying, via a first adhesive application system, a first adhesive to at least a portion of a perimeter of a section of a first web that defines a bottom layer of a panel of the padded mailer. The first adhesive is configured to adhere the perimeter of the section of the first web to a perimeter of a section of a second web that defines a top layer of the panel so as to form the panel. The section of the first web further defines an internal area surrounded by the perimeter. The section of the second web further defines an internal area surrounded by the perimeter. The method further includes applying, via a second adhesive application system, an expandable second adhesive to the internal area of the section of the first web. The method further includes applying, via an additive application system, an additive liquid to at least one of the internal area of the section of the first web or the internal area of the section of the second web prior to bringing the section of the first web and the section of the second web into contact with each other. The method further includes operating an oven to provide energy, after the section of the first web and the section of the second web contact each other, to energize the additive liquid and the expandable second adhesive to cause the expandable second adhesive to expand in thickness to form padding for the panel of the padded mailer.

In some embodiments, the method further includes operating a cooling element to apply cooling to the padded mailer after the padded mailer passes through the oven so as to retain thickness expansion of the padding for the padded mailer.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows an example padded mailer, in accordance with some embodiments discussed herein;

FIG. 2 is a cross-sectional view of the padded mailer shown in FIG. 1 taken along line 2-2, wherein the expandable adhesive has expanded to an example desired thickness;

FIG. 3A is another example cross-sectional view of another example padded mailer, wherein less expandable adhesive was applied for each internal pouch of each panel, and wherein a smaller thickness was the result;

FIG. 3B shows two graphs representing an average measurement thickness for the expandable adhesive within a padded mailer based on oven belt speed;

FIG. 4A is another example cross-sectional view of another example padded mailer, wherein the same amount of expandable adhesive was applied for each internal pouch of each panel as in FIG. 3A, however, the expandable adhesive expanded to the desired thickness as in FIG. 1 through utilization of additive liquid, in accordance with some embodiments discussed herein;

FIG. 4B shows two graphs representing an average measurement thickness for the expandable adhesive within a padded mailer based on oven belt speed, where additive liquid was added, in accordance with some embodiments discussed herein;

FIG. 5 shows a schematic representation of an example system for forming a padded mailer, wherein an additive application system is included, in accordance with some embodiments discussed herein;

FIG. 6 shows an example portion of the first web along a web path within the example system of FIG. 5, wherein the example portion of the first web illustrates utilization of an expandable adhesive application system and an additive application system, in accordance with some embodiments discussed herein;

FIG. 7 shows an example portion of the second web along a web path within the example system of FIG. 5, in accordance with some embodiments discussed herein;

FIG. 8 shows a schematic representation of another example system for forming a padded mailer, wherein an additive application system is included prior to the expandable adhesive application system, in accordance with some embodiments discussed herein;

FIG. 9 shows a schematic representation of another example system for forming a padded mailer, wherein an additive application system is included for application to the second web, in accordance with some embodiments discussed herein;

FIG. 10 shows a schematic representation of a portion of an example system for forming a padded mailer, wherein the additive application system includes a spray device configured for misting the additive liquid onto the first web, in accordance with some embodiments discussed herein;

FIG. 11 shows a schematic representation of a portion of an example system for forming a padded mailer, wherein the additive application system includes a spray device for dripping the additive liquid onto the first web, in accordance with some embodiments discussed herein;

FIG. 12 shows a schematic representation of a portion of an example system for forming a padded mailer, wherein the additive application system includes a roller for applying the additive liquid onto the first web, in accordance with some embodiments discussed herein;

FIG. 13 shows a schematic representation of a portion of an example system for forming a padded mailer, wherein the additive application system includes two spray devices configured for misting the additive liquid onto the first web, wherein the spray devices are positioned at separate application sites along the first web, in accordance with some embodiments discussed herein;

FIG. 14 illustrates a flowchart of an example method for forming a padded mailer, in accordance with some embodiments discussed herein; and

FIG. 15 illustrates a flowchart of another example method for forming a padded mailer, in accordance with some embodiments discussed herein.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

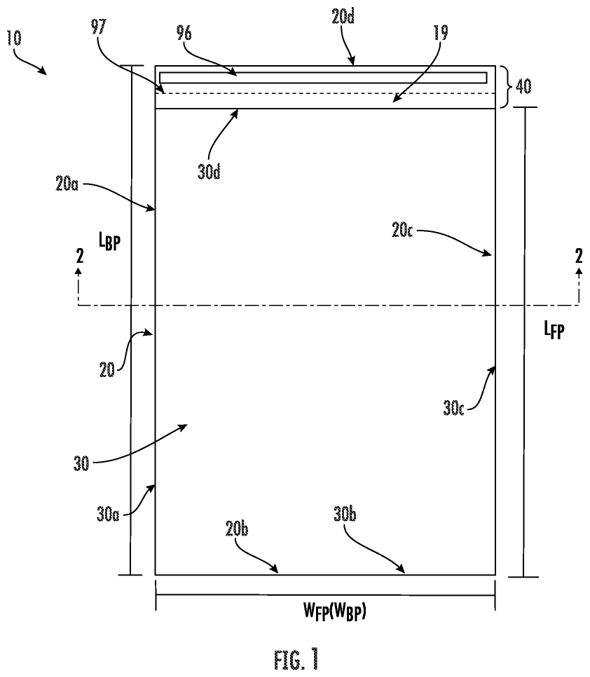

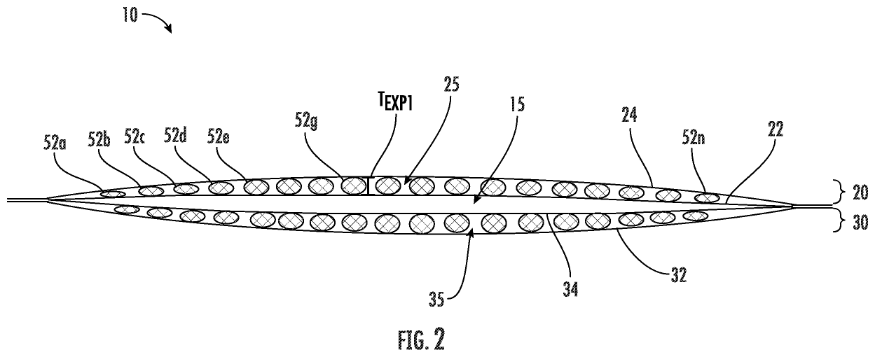

FIG. 1 shows an example padded mailer 10 contemplated by various embodiments of the present invention. The illustrated padded mailer 10, which is shown in the open, ready for packaging configuration, includes a front panel 30 and a back panel 20. The front panel 30 defines a width M_{FP} and a length L_{FP} and includes four edges 30a, 30b, 30c, and 30d. The back panel 20 defines a width W_{BP} and a length L_{BP} and includes four edges 20a, 20b, 20c, and 20d. In the open, ready for packaging configuration, the front panel 30 and the back panel 20 are attached along three edges (20a/30a, 20b/30b, and 20c/30c), such as via seam adhesive being positioned proximate the edges. Notably, the fourth edge 30d of the front panel 30 is not attached to the back panel 20 (or only attached near the corners) and, instead, an opening 19 to a pocket 15 (shown in FIG. 2) is formed—allowing insertion of the item(s) for shipping and delivery.

The dimensions of the padded mailer may vary depending on the desired application. An example padded mailer includes a back panel length L_{BP} of ˜20.125 in. and a back panel width W_{BP} of ˜14 in.

Notably, the length L_{BP} of the back panel 20 is greater than the length L_{FP} of the front panel 30 such that a portion 40 of the back panel 20 extends above the fourth edge 30d of the front panel 30. The portion 40 of the back panel 20 can, thus, be used in sealing the padded mailer 10, such as once the item to be shipped and delivered is placed inside. In this regard, various features for aiding in packaging and opening of the padded mailer can be positioned within the portion 40. For example, FIG. 1 illustrates an example pull-strip 96 for revealing a strip of adhesive that can be used to attach the portion 40 to the front panel 30 once the portion 40 has been folded over to cover the opening 19—thereby transitioning the padded mailer into the sealed configuration. Once the sealed padded mailer has been delivered to its end destination, a tear strip 97 can be pulled to enable access to the internal pocket 15 and, thus, the item stored therein.

Notably, embodiments of the present invention contemplate various features and configurations of a padded mailer that can be utilized. Thus, the illustrated example is not meant to be limiting. For example, in some embodiments, the front panel and the back panel may have similar lengths, the front panel and the back panel may be attached around an item, and/or other configurations are contemplated.

With reference to FIG. 2, in the illustrated embodiment, the panels 20, 30 connect along the edges to form the pocket 15 for receiving the item to be shipped and delivered therein. Additionally, however, FIG. 2 illustrates that each panel 20, 30 includes an internal pouch 25, 35, respectively. For example, such as further described herein, the internal pouch 25 is formed after attachment of section 22 of a first web and section 24 of a second web, while the internal pouch 35 is formed after attachment of section 32 of a third web and section 34 of fourth web.

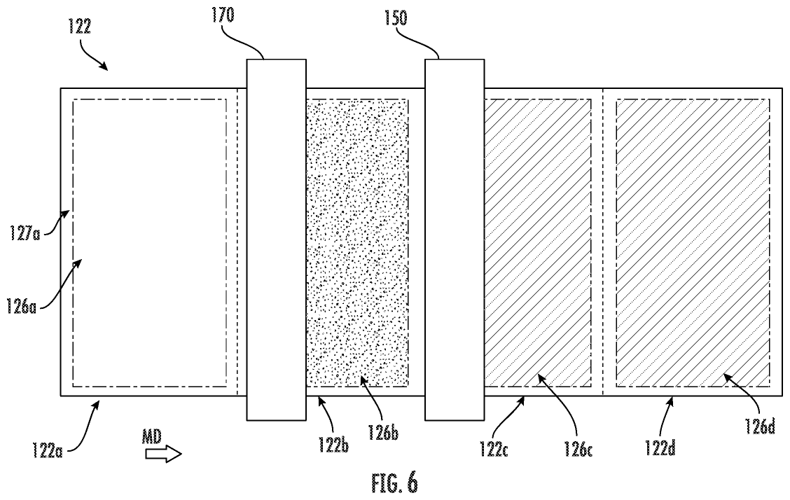

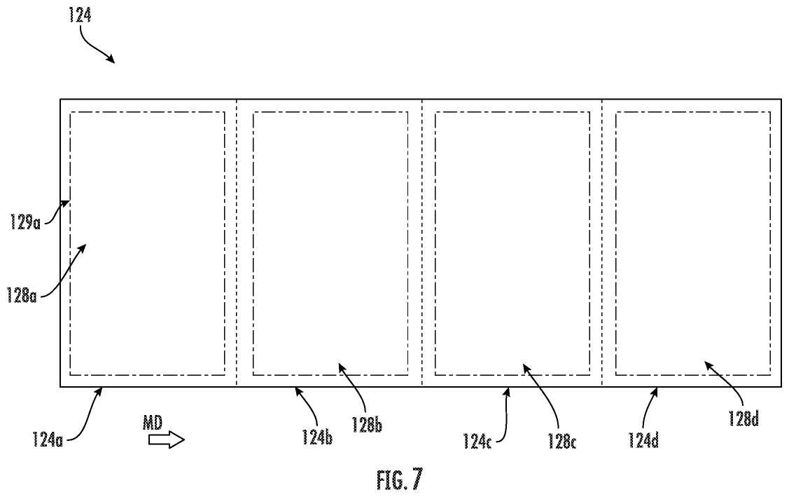

As noted herein, various embodiments of the present invention contemplate forming a padded mailer. As shown in FIG. 2, the expandable adhesive may be positioned as separate droplets 52a, 52b, 52c, 52d, 52e, . . . 52n within the internal pouches 25, 35. Jumping ahead briefly to FIGS. 6 and 7, a panel may be formed by bringing together a section 122a of a first web 122 (FIG. 6) and a section 124a of a second web 124 (FIG. 7). The section 122a of the first web 122 may include a perimeter 127a and an internal area 126a. Likewise, the section 124a of the second web 124 may include a corresponding perimeter 129a and an internal area 128a. The expandable adhesive may be applied, for example, to the internal area 126a of the first web 122, while a seam adhesive may be applied to the perimeter 127a. Thus, when the section 124a of the second web 124 is brought into contact with the corresponding section 122a of the first web 122, the internal pouch (e.g., 25 in FIG. 2) is formed with the expandable adhesive positioned therein.

Returning to FIG. 2, after the panels 20, 30 of the padded mailer 10 are formed and then connected to form the padded mailer 10, the padded mailer 10 may be passed through an oven (e.g., a radiofrequency (RF) dryer—although other energy transferring ovens are also contemplated) to cause the expandable adhesive inside each internal pouch 25, 35 to expand, such as to the thickness T_{EXP1} for droplet 52g shown in FIG. 2 near the center of the internal pouch. In this regard, though different thicknesses are shown, in some embodiments, each droplet may expand to a comparable thickness and/or only certain droplets may expand to a desired thickness—as many different configurations are contemplated.

Notably, as used herein, a desired thickness may, for example, correspond to a maximum thickness or an average thickness of the droplets. For example, the average thickness at a plurality of locations on the padding may be measured and averaged to determine the average thickness. In some example embodiments, the thickness at 4 different locations on the padding may be measured (e.g., near each corner of the padded mailer). In some such example embodiments, the selected locations may be at least 1 in. away from the edge to account for tension in the webs that may otherwise restrict expansion ability. In some embodiments, the thickness of the padding for the mailer may be measured between two measurement plates with a constant load applied. In this regard, unless otherwise stated, the example specific thickness measurements included herein correspond to the overall thickness for the mailer (e.g., 4 webs, 2 internal pouches, and a pocket)—e.g., as opposed to the thickness T_{EXP1} of the droplets within one internal pouch (shown in FIG. 2).

As an example measurement technique, the completed, expanded mailer may be placed between two measurement plates at least 2 minutes after being removed from the oven. The measurement plates may be made from hard coat anodized aluminum and are, for example, 3.5 in.×3.5 in. A constant load of 250 g (or 0.045 psi pressure) is applied to the plates for sandwiching the mailer therebetween. The resulting distance between the plates when the plates settle with the mailer sandwiched therebetween is measured as the thickness measurement. The plates and/or mailer are moved relative to each other to cause thickness measurements for at least 4 locations, such as proximate each corner of the padding (which may be ˜2 in. from the top edge or bottom edge and ˜1 in. from each side edge—but may depend on the relative overall size of the mailer—such that each measurement is made in the padding section of the mailer). In some cases, there may be overlap in the measured portions of the mailer. This results, for example, in four thickness measurements (top left corner, top right corner, bottom left corner, and bottom right corner). The measurements may be averaged together to provide the average thickness for the mailer.

Additional information regarding example expandable adhesives usable for forming padding in padded mailers may be found in the following references which are each incorporated herein by reference in their entireties: U.S. Pat. No. 9,849,655, entitled “Adhesive for Insulative Articles”, issued December 26, 2017; U.S. Publication No. 2019/0218419, entitled “Dielectric Heating of Foamable Compositions”, published Jul. 18, 2019; U.S. Publication No. 2019/0284438, entitled “Dielectric Heating of Foamable Compositions”, published Sep. 19, 2019; and U.S. Publication No. 2019/0062028, entitled “Process for Forming Improved Protective Eco-Friendly Pouch and Packaging and Products Made Therefrom”, published Feb. 28, 2019.

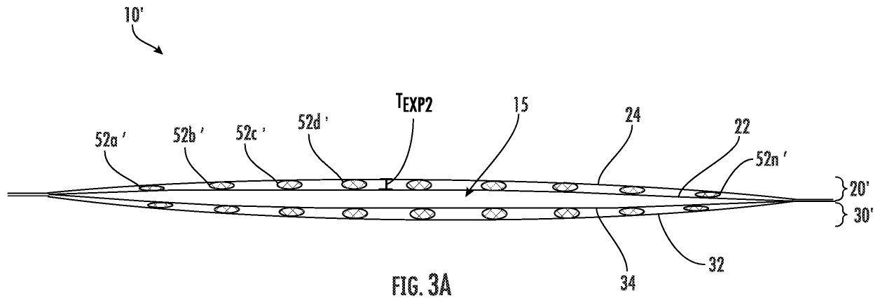

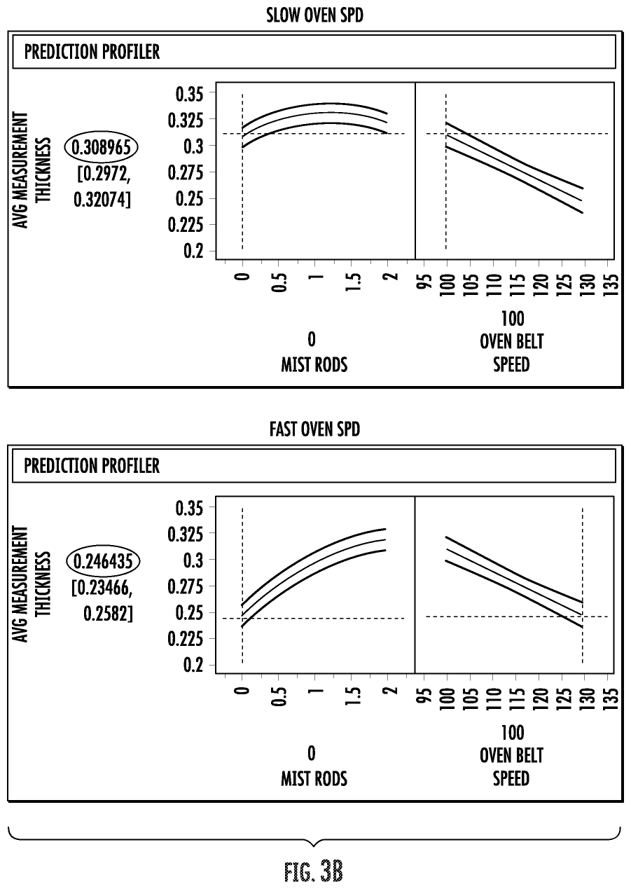

In an effort to create a more efficient padded mailer and reduce overall material usage, the amount of expandable adhesive being applied within each internal pouch was reduced. However, there was still a desire to maintain the prior thickness (e.g., the thickness T_{EXP1} for droplet 52g shown in FIG. 2) in order to maintain the desired padding properties for the padded mailer. FIG. 3A illustrates such an example padded mailer 10′ that includes less expandable adhesive droplets 52a′, 52b′, 52c′, 52d′, . . . 52n′ inside the internal pouches (although in some embodiments, the same number of droplets as shown in FIG. 2 is contemplate—just with less expandable adhesive per droplet). Notably, however, when passing the formed padded mailer 10′ through the same drying process (e.g., operating the oven at the prior operation speed) a reduced thickness T_{EXP2} was observed, such that T_{EXP2} is less than T_{EXP1}. Additionally, it is noted that a more uneven or non-uniform expansion occurred. Further experimentation resulted in an understanding that a reduction in operating speed of the oven (and, thus, an increase in exposure time of the padded mailer 10′) resulted in the return of a similar thickness to that shown in FIG. 2 as well as a return to more of a uniform expansion. For example, with reference to FIG. 3B, the image on the left shows that a slower oven belt speed of 100 feet per minute results in an average measurement thickness of ˜0.31 in. for the expandable adhesive (shown as dotted horizontal line in the right graph of the left image), whereas the image on the right shows that a faster oven belt speed of 130 feet per minute results in an average measurement thickness of ˜0.25 in. (shown as dotted horizontal line in the right graph of the right image).

Some embodiments of the present invention seek to maintain a desired production rate and thickness of the expandable adhesive while still reducing the amount of expandable adhesive needed (which may assist in achieving reduced material costs). The process for forming padded mailers includes aligning various operating speeds for various systems during manufacturing (e.g., transportation speeds of the various webs, operation speed of the oven, operation speed of the adhesive application systems, etc.), particularly when the systems are in-line with each other. In this regard, slowing of the oven operating speed to achieve the desired thickness (such as contemplated with the image on the left in FIG. 3B) would adversely affect one or more other operations of the manufacturing process (e.g., a reduction in the rate of production of the padded mailers, a reduction in the operating speed of various other systems, etc.).

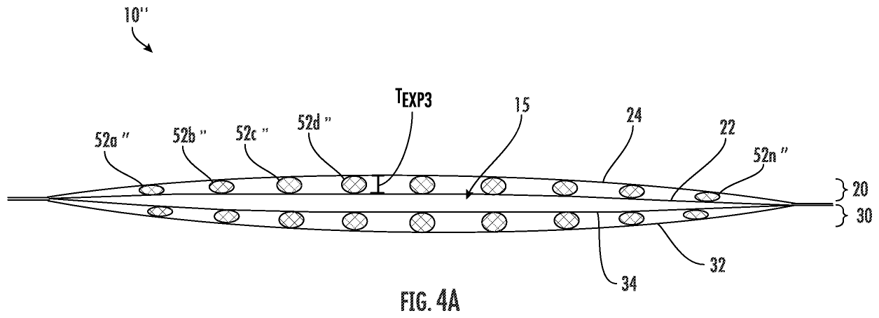

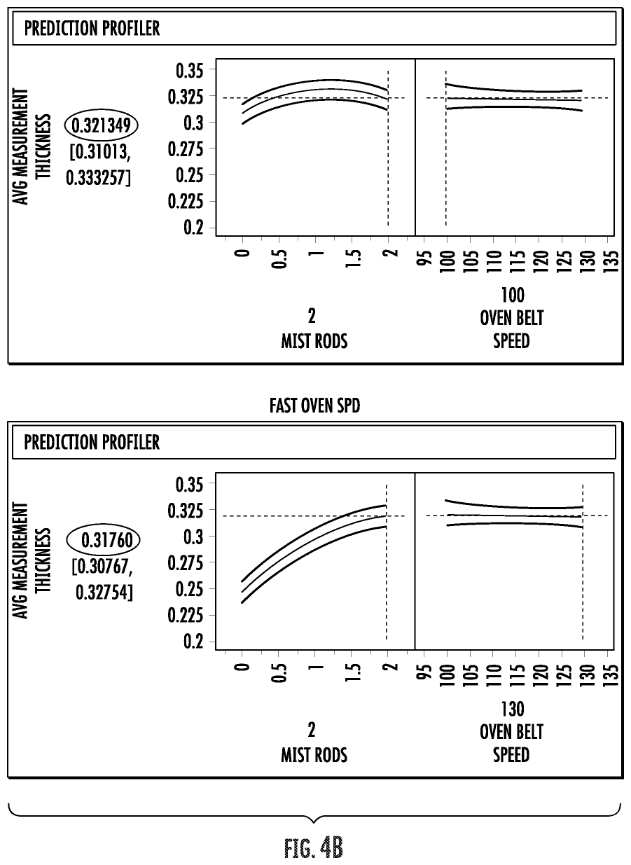

Some embodiments of the present invention contemplate applying additive liquid to one or more of the webs used with the expandable adhesive prior to or in conjunction with expanding or drying the expandable adhesive to form the padding. In this regard, some such example embodiments are able to maintain the reduced amount of expandable adhesive and still maintain operation speed of the oven and other systems—thereby keeping production rate and system operation at a desirable speed—all while still maintaining a desired thickness of the padding. To explain, without being bound by theory, the expandable adhesive includes water that has polar molecules that, when energized (such as from energy of an oven), excite to cause the expansion of the expandable adhesive (such as through friction heating). With less expandable adhesive within the internal pouch of each panel, there is less water to be excited and, thus, there is less expansion over a similar amount of time (and under similar conditions otherwise). In order to increase the efficiency of expansion of the expandable adhesive, the additive liquid includes polar molecules (such as from water) that are applied within the internal pouch. Thus, the combination of the expandable adhesive and the additive liquid result in expansion of the expandable adhesive to a desired thickness within a desired amount of time within the oven—thereby enabling efficient operation and manufacturing of the padded mailers. FIG. 4A shows an example padded mailer 10″ that utilizes the same amount of expandable adhesive as the padded mailer 10′ shown in FIG. 3A, but because of the addition of the additive liquid, the expandable adhesive (e.g., droplets 52a″, 52b″, 52c″, 52d″, . . . 52n″) expanded to the desired thickness T_{EXP3} that is similar to the thickness T_{EXP1} shown in FIG. 2 when dried at the same rate as 10.

The amount of additive liquid applied per padded mailer may vary depending on various circumstances (e.g., the amount of expandable adhesive, the type of expandable adhesive, the desired thickness, the operating speed and/or output energy of the oven, the type of web utilized, among other things).

An example where the additive liquid improved the efficiency of expansion of the expandable adhesive is shown below in FIG. 4B. For example, the image on the left shows that, when 0.5 grams of additive liquid was applied (each mist rod produced 0.25 grams of water per panel, and there are two panels in each padded mailer), a slower oven belt speed of 100 feet per minute results in an average measurement thickness of ˜0.32 in. for the expandable adhesive (shown as dotted horizontal line in the right graph of the left image), whereas the image on the right shows that, when 0.5 grams of additive liquid was applied for a panel, a faster oven belt speed of 130 feet per minute also results in an average measurement thickness of ˜0.32 in. (shown as dotted horizontal line in the right graph of the right image). As such, considering the right image of each of FIG. 3B and FIG. 4B, the addition of 0.5 grams of water resulted in an increase of average measurement thickness from ˜0.25 in. to ˜0.32 in. while the oven operated with belt speed of 130 feet per minute. Moreover, as illustrated by the shape of the representation of the padding in the right graph of the right image of FIG. 4B, the observed thickness throughout the padding was more uniform than the shape of the representation of the padding in the right graph of the right image of FIG. 3B.

In some embodiments, various ranges of the amount of expandable adhesive and the amount of additive liquid applied are contemplated while producing a desired thickness and maintaining a desired oven operating speed. As an example, ˜0.001-0.018 g/in.² of additive liquid comprising water was applied per mailer. This allowed a reduction of ˜0.008-0.015 g/in.² of applied expandable adhesive per mailer to still produce a similar desired thickness (e.g., without additive liquid, ˜0.022-0.045 g/in.² of expandable adhesive per mailer was expanded to ˜0.30 in—while, with additive liquid, ˜0.014-0.030 g/in.² of expandable adhesive per mailer was expanded to a similar thickness of ˜0.28 in)—all while maintaining the desired operating speed of the oven (e.g., at 130 feet per minute). Notably, as described herein, embodiments of the present invention also contemplate the ability to speed up operation speeds of the oven beyond past performance with the same amount of expandable adhesive due to the additive liquid being applied (e.g., an example benefit may be described as increased production rate in addition to or instead of reduced material cost).

Some embodiments of the present invention contemplate any composition for the additive liquid that includes polar molecules that are excited when energized, such as from an oven. In some embodiments, the additive liquid may be water or include water. In some embodiments, the additive liquid may be an aqueous solution. In some embodiments, the additive liquid may include one or more non-water additives, such as salt. In some embodiments, different amounts of additives may vary, such as depending on various factors (e.g., the amount of expandable adhesive, the type of expandable adhesive, the desired thickness, the operating speed and/or output energy of the oven, the type of web utilized, among other things).

In some embodiments, the additive liquid may undergo heating or cooling prior to or in conjunction with application to the web, such as to aid in expansion of the expandable adhesive and additive liquid. For example, a heating element may apply heat to the additive liquid during application to the web. Such heat may aid in speeding up expansion of the expandable adhesive and additive liquid when energized, such as by the oven.

In some embodiments, the additive liquid may be selected to interact with certain material that is otherwise present. For example, additive material may be applied to the web, such as via printing or coating, that are designed to interact (e.g., through a catalyzed reaction) with the additive liquid to aid in expansion of the expandable adhesive and additive liquid, such as when the expandable adhesive and additive liquid are energized.

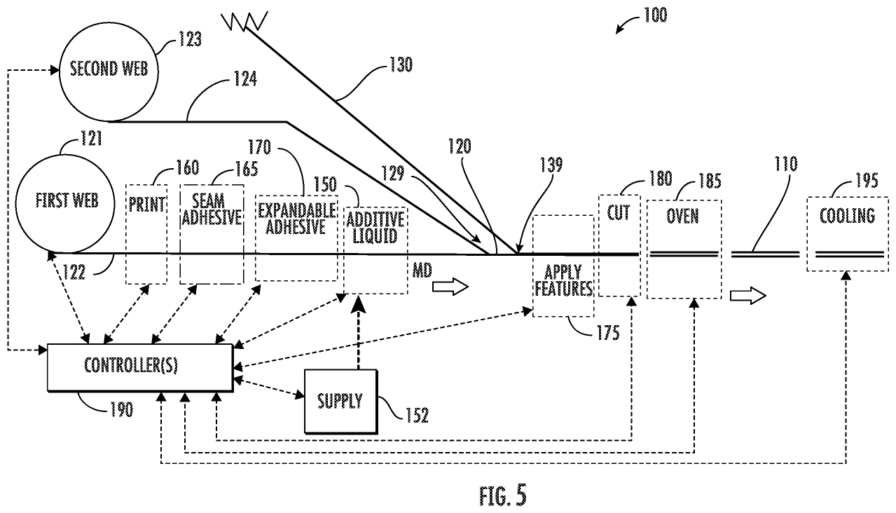

FIG. 5 shows a schematic representation of an example system 100 for forming a padded mailer that utilizes an additive application system. The system 100 may, such as through controller 190, cause conveyance of one or more paper-based webs, such as along the machine direction (MD) arrow. For example, one or more conveyor means (e.g., a conveyor belt, one or more rollers, etc.) and/or motors may be used to cause a roll 121 of a first web 122 to pass through a print phase 160, a seam adhesive application phase 165, an expandable adhesive application phase 170, and an additive application phase 150. After that, the conveyor means may cause the first web 122 to combine with the second web 124 (such as from a roll 123 of the second web 124) at a combination point 129 to form the bottom panels 120 for the padded mailer. Then, the conveyor means may cause the bottom panels 120 to combine with top panels 130 (such as may have gone through a similar process) at combination point 139 (this may include application of adhesive prior to the combination to enable the bottom panel 120 and the top panel 130 to attach to each other and form the pocket therebetween). Thereafter, the unexpanded padded mailer may pass through a feature application phase 175, a cut phase 180, and an oven phase 185 prior to being formed into padded mailers 110. In some embodiments, the expanded padded mailers 110 may pass through a cooling phase 195.

Notably, in conjunction with various embodiments described herein, various of the phases can be combined, changed in order of operation, separated, or otherwise changed. For example, while the illustrated embodiments show a padded mailer formed by bring four webs together, other formation processes are contemplated. For example, the web may be folded over onto itself to form one or more of the internal pouches and/or the pocket of the padded mailer. In such example embodiments, the corresponding phases may be adjusted accordingly.

The controller 190 provides logic and control functionality used during operation of the system 100. In some embodiments, the functionality of the controller 190 may be distributed to several controllers that each provides more limited functionality to discrete portions of the operation of system 100. The controller 190 may comprise one or more suitable electronic device(s)/server(s) capable of executing described functionality via hardware and/or software control. In some embodiments, the controller 190 may include one or more user interfaces (not shown), such as for displaying information and/or accepting instructions. The controller 190 can be, but is not limited to, a microprocessor, microcomputer, a minicomputer, an optical computer, a board computer, a complex instruction set computer, an ASIC (application specific integrated circuit), a reduced instruction set computer, an analog computer, a digital computer, a molecular computer, a quantum computer, a cellular computer, a solid-state computer, a single-board computer, a buffered computer, a computer network, a desktop computer, a laptop computer, a personal digital assistant (PDA) or a hybrid of any of the foregoing.

The controller 190 may include one or more processors coupled to a memory device. Controller 190 may optionally be connected to one or more input/output (I/O) controllers or data interface devices (not shown). The memory may be any suitable form of memory such as an EPROM (Erasable Programmable Read Only Memory) chip, a flash memory chip, a disk drive, or the like. As such, the memory may store various data, protocols, instructions, computer program code, operational parameters, etc. In this regard, the controller 190 may include operation control methods embodied in application code. These methods are embodied in computer instructions written to be executed by one or more processors, typically in the form of software. The software can be encoded in any suitable language, including, but not limited to, machine language, assembly language, VHDL (Verilog Hardware Description Language), VHSIC HDL (Very High Speed IC Hardware Description Language), Fortran (formula translation), C, C++, Visual C++, Java, ALGOL (algorithmic language), BASIC (beginners all-purpose symbolic instruction code), visual BASIC, ActiveX, HTML (HyperText Markup Language), and any combination or derivative of at least one of the foregoing. Additionally, an operator can use an existing software application such as a spreadsheet or database and correlate various cells with the variables enumerated in the algorithms. Furthermore, the software can be independent of other software or dependent upon other software, such as in the form of integrated software. In this regard, in some embodiments, the controller 190 may be configured to execute computer program code instructions to perform aspects of various embodiments of the present invention described herein.

The controller 190 may be operably coupled with one or more components of the system 100, including for example, the roll 121 of the first web 122 (or corresponding web management device for controlling translation of the first web 122 along the web path), the roll 123 of the second web 124 (or corresponding web management device for controlling translation of the second web 124 along the web path), various components of the printing phase 160, various components of the seam adhesive application phase 165, various components of the expandable adhesive application phase 170, various components of the additive application phase 150 (e.g., the supply 152), various components of the feature application phase 175, various components of the cut phase 180, various components of the oven phase 185, conveyance means of the system 100 (including for the top panel 130 and the components used in formation thereof), and other components (such as described herein). For example, depending on the components, the controller 190 may be operably coupled such as through use of solid-core wiring, twisted pair wiring, coaxial cable, fiber optic cable, mechanical, electrical, wireless, radio, infrared, etc. In this regard, depending on the components, the operable coupling may be through one or more intermediate controllers or mechanical coupling, such as used for controlling some components (e.g., controlling operation and/or feeding of the roll 121 of the first web 122). In some embodiments, the controller 190 may be configured to provide one or more operating signals to these components and to receive data from these components.

During the printing phase 160, the controller 190 may direct a printer to print one or more images at specific locations on the first web 122. Any image (including words, markers, instructions, etc.) are contemplated by various embodiments of the present invention. For example, various labels corresponding to the padded mailer may be printed onto the first web (such as the face of the first web that will face outside of the padded mailer). As another example, a barcode or other identifier may be printed to be used, such as during shipping and/or delivery. Although the example figures show the first web undergoing printing, in some embodiments, in addition to or in the alternative, the second web 124 may undergo printing through the printing phase 160.

During the seam adhesive application phase 165, the controller 190 may be configured to cause application, such as from a seam adhesive application device, of adhesive onto portions of the first web 122. For example, such adhesive may be applied to ultimately help form the seam of the panel in conjunction with a corresponding portion of the second web 124. For example, with reference to FIG. 6, the seam adhesive may be applied in the perimeter 127a of each section 122a of the first web 122. Accordingly, when combined with the second web 124 (shown in FIG. 7), the perimeter 127a of the first web 122 may attach and adhere to the perimeter 129a of the second web 124—thereby forming an internal pouch (e.g., the pouch 25 shown in FIG. 2). The seam adhesive may be any type of adhesive that enables adherence between the first web and the second web. In some embodiments, the seam adhesive may be configured to cure or dry when the padded mailer is passed through the oven phase 185. Depending on the desired configuration, the seam adhesive may only be applied to a portion of the perimeter 127a of the first web 122, such as to form air vents that may be utilized during expansion of the expandable adhesive. In some embodiments, other configurations or applications of the seam adhesive are contemplated, such as applying the seam adhesive to the second web 124 (e.g., in addition to or in the alternative to applying the seam adhesive to the first web 122).

During the expandable adhesive application phase 170, the controller 190 may be configured to cause application, such as from an expandable adhesive application device, of expandable adhesive onto portions of the first web 122. Any type of application of the expandable adhesive is contemplated, such as dripping droplets onto the first web. For example, with reference to FIG. 6, the expandable adhesive may be applied in the internal area 126a of each section 122a of the first web 122. With the web path running from left to right, the expandable adhesive has been applied to the internal area 126b of section 122b, the internal area 126c of section 122c, and the internal area 126d of section 122d. Accordingly, once the internal pouch is formed after the section 122a of the first web 122 is combined with the section 124a of the second web 124, the internal pouch may, thus, include the expandable adhesive therein. Notably, in some embodiments, as described herein, the expandable adhesive is configured to expand upon exposure to an oven (e.g., a radiofrequency (RF) dryer). In some such embodiments, the expandable adhesive may also operate to adhere the second web and the first web while still maintaining the desired thickness (and padding) therebetween.

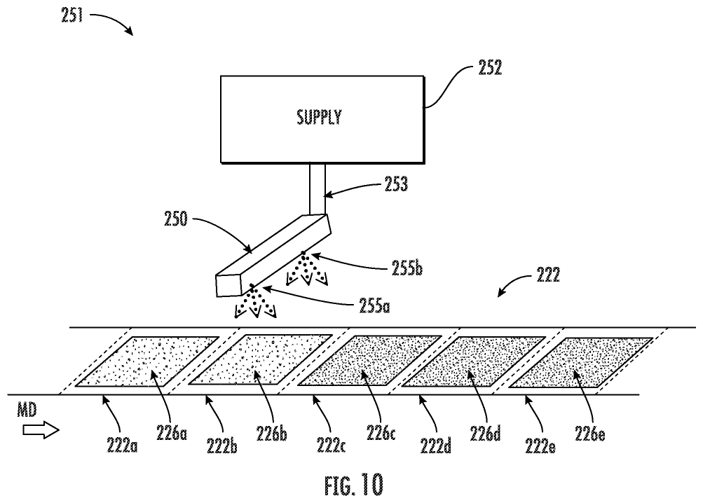

During the additive application phase 150, the controller 190 may be configured to cause application, such as from an additive application device (or multiple devices), of additive liquid onto portions of the first web 122. Such additive liquid may come from one or more supplies 152. Various example application devices are described herein and illustrated with respect to FIGS. 10-13. With reference to FIG. 6, the additive application phase 150 may include providing the additive liquid onto the first web 122, such as into an internal area 126a of each section 122a (although application to any area or portion of the section 122a of the first web 122 is contemplated). With the web path running from left to right, the additive liquid has been applied to the internal area 126c of section 122c and the internal area 126d of section 122d. In this regard, the additive liquid may be positioned within the internal pouch and ready for being energized along with the expandable adhesive by the oven, such as described herein. Notably, in various embodiments, the additive liquid may be applied to more of or different portions of the first web 122. For example, the additive liquid may be applied to the entire section 122a, such that it is at least applied to the internal area 126a of the section 122a.

In the illustrated embodiment of FIG. 5, the system 100 includes the additive application phase 150 after the expandable adhesive application phase 170 and provides for application of the additive liquid onto the first web 122. Notably, application of the additive liquid onto the first web 122 with the expandable adhesive provides the benefit of the expandable adhesive absorbing the additive liquid directly, and some of the additive liquid may not be drawn into the first web directly. This increases efficient expansion of the expandable adhesive and reduces any effects on the first web.

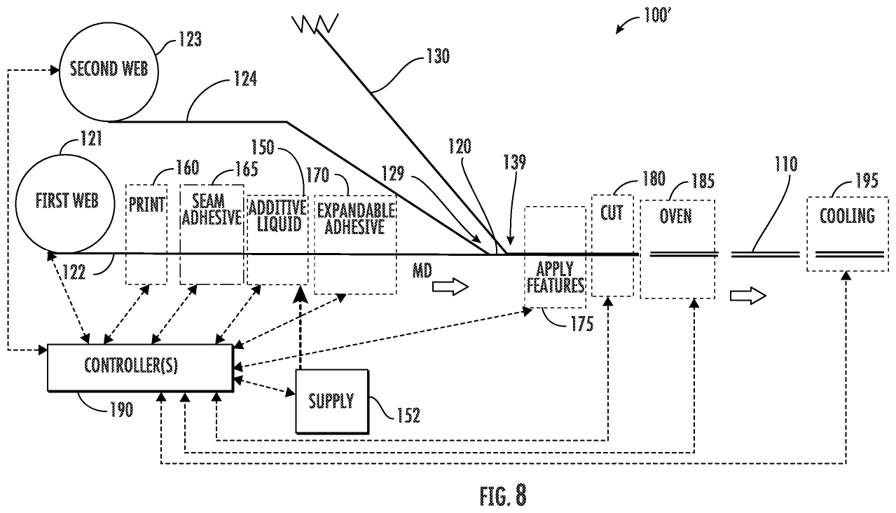

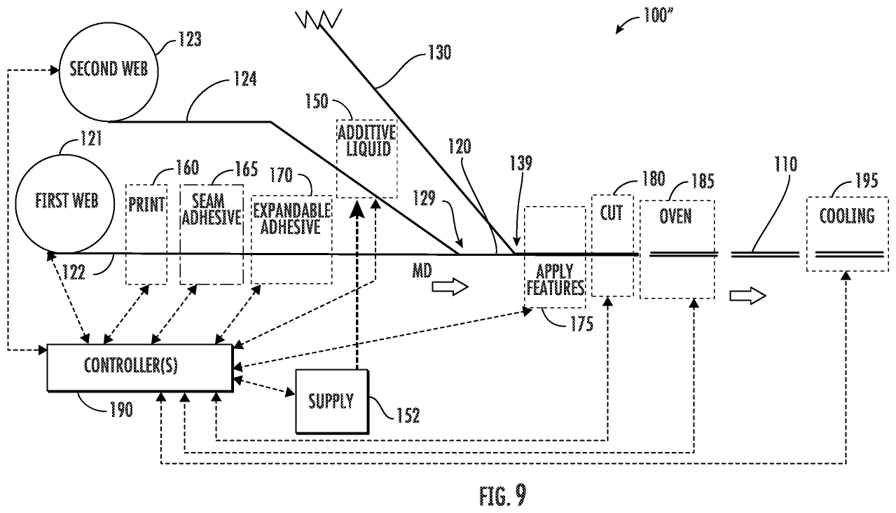

In various embodiments, however, other configurations are contemplated. For example, with reference to FIG. 8, the system 100′ may include providing the additive application phase 150 prior to the expandable adhesive application phase 170. As another example, with reference to FIG. 9, the system 100″ may include providing the additive application phase 150 such that the additive liquid is applied to the second web 124 instead of the first web 122. As additional alternatives, different positions along the web path(s) are contemplated (e.g., downstream of the expandable adhesive application phase 170, upstream of the expandable adhesive application phase 170, or at other points). Along these lines, application of the additive liquid may occur after formation of one or more of the panels or the entire padded mailer. In some embodiments, application of the additive liquid may occur just prior to or while the padded mailer is inside the oven. For example, as detailed herein, the additive liquid may be applied in a mist form or in a steam form that then applies to the padded mailer. Such application may occur outside of the internal pouch (where the expandable adhesive is), but still may have the desired effect of increasing efficiency of expansion of the expandable adhesive. In this regard, in some embodiments, the additive liquid may adjust the environment within the oven to a situation that leads to more efficient expansion of the expandable adhesive.

Moreover, as further alternatives, additional (e.g., multiple) application sites for the additive liquid can be employed. Such additional application sites may be positioned at any point along the first web path (e.g., downstream of the expandable adhesive application phase 170, upstream of the expandable adhesive application phase 170, or at other points) and/or along the second web path.

Returning to FIG. 5, with the expandable adhesive and the additive liquid applied, the first web 122 and the second web 124 can be brought together (e.g., combined) to form a bottom panel 120 of the padded mailer, such as at connection point 129. Thereafter, the bottom panel 120 and a top panel 130 (coming from a separate and similar process) may be brought together (e.g., combined) to form the unexpanded padded mailer, such as at connection point 139.

During the feature application phase 175, the controller 190 may be configured to cause application of one or more features to the unexpanded padded mailer, such as may be used for packaging and/or opening of the padded mailer. For example, with reference to FIG. 1, a strip of adhesive and a corresponding pull-strip for revealing the strip of adhesive can be applied. As another example, a tear strip can be applied. Other features or additions to the padded mailer are also contemplated.

During the cut phase 180, the controller 190 may be configured to cut out the unexpanded padded mailers (which are still connected along their lengths since their layers are in web form). In this regard, the controller 190 may be operably coupled to the various knives to control operation during the cutting phase 180.

During the oven phase 185, the controller 190 may be configured to operate one or more components of the oven to cause the padded mailer (and its various parts) to be energized (e.g., dried). Notably, any type of oven may be used, although some embodiments of the present invention contemplate utilizing a radiofrequency (RF) dryer to cause expansion of the expandable adhesive as described herein. Further, various components may be utilized during the oven phase, such as oven belts, motors, vents, healing elements, etc. As detailed herein, the oven may apply energy to the additive liquid and the expandable adhesive within the internal pouch of one or more of the panels to cause expansion of the expandable adhesive to a desired thickness. Additionally, in some embodiments, the oven may also be used to dry or cure the seam (or other) adhesive.

After the padded mailer 110 exits the oven, the panels have expanded so as to include the padding. Additional processing and logistics corresponding with the manufacturing process may thereafter take place.

For example, the expanded padded mailer 110 may enter a cooling phase 195. In the cooling phase 195, one or more cooling elements may apply cooling to the expanded padded mailer 110 to “lock-in” the expansion of the padding that occurred within the oven phase 185. Some example cooling elements include one or more fans, one or more compressed air nozzles, one or more temperature control elements, among others. In some embodiments, cooling at approximately 170° F. may be provided within the cooling phase 195 (although other temperatures are contemplated, such as any temperature within 150° F.-190° F., within 165° F. to 175° F., etc.). By applying cooling to the recently expanded padded mailers, the current expansion level of the padding may be maintained and/or an amount of reduction in expansion level of the padding that may otherwise occur while natural cooling occurs may be reduced. In this regard, it has been seen that the level of expansion of the padding that occurred within the oven may not last (e.g., it may reduce) over time after leaving the oven, ultimately settling at a resting expansion thickness that is less than the level of expansion achieved within the oven. However, by applying cooling to the padded mailer after expansion occurs, there is less reduction of the expansion thickness to when the resting expansion thickness is achieved. Further, this is helpful in reducing the amount of time needed to reach a resting expansion thickness, thereby enabling earlier positioning of the expanded padded mailer in a stack of padded mailers, such as for shipping to customers. Notably, if the expanded padded mailers are prematurely put into a stack (e.g., before a resting expansion thickness is reached), the weight applied to the recently expanded padded mailer (such as due to other padded mailers being placed on top of them) may cause the level of expansion to reduce.

FIG. 10 shows a schematic representation of a portion of an example system for forming a padded mailer. In particular, FIG. 10 illustrates an example additive application system 251 that includes an additive application device 250 with two spray devices 255a, 255b. The two spray devices 255a, 255b are spread apart on a fluid delivery structure (e.g., a pipe) so as to cover the length of the first web 222 (or the length of the internal area 226b of the first web 222). During operation, the additive liquid is feed from the supply 252 through one or more delivery structures 253 and out of the spray devices 255a, 255b onto the first web 222. In the illustrated embodiment, the spray devices 255a, 255b are configured to cause the additive liquid to mist onto the first web 222 (e.g., a corresponding nozzle for each spray device may be configured to promote misting). In such a manner, the additive liquid may not disturb the first web 222 or anything already on the first web 222 (e.g., the application of the additive liquid may not cause through direct application force the expandable adhesive droplets to change shape or position on the web). In the illustrated embodiment, the additive liquid is being applied in the internal area 226b of the section 222b of the first web 222 (which already includes the expandable adhesive).

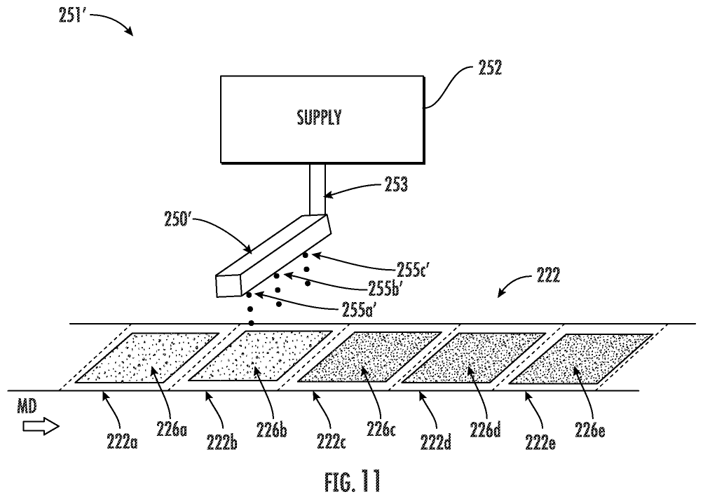

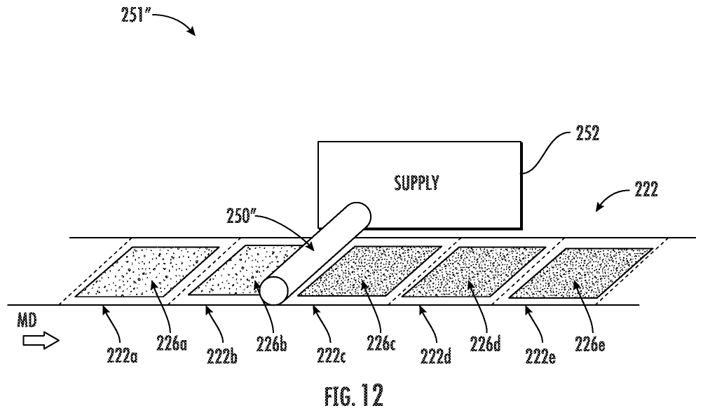

Notably, other suitable forms of application are also contemplated by various example embodiments of the present invention. For example, with reference to FIG. 11, the additive application system 251′ includes an additive application device 250′ that includes three spray devices 255a′, 255b′, 255c′ that are configured to drip the additive liquid onto the first web 222. As another example, with reference to FIG. 12, the additive application system 251″ includes an additive application device 250″ in the form of a roller that rolls onto the first web 222 to apply the additive liquid thereto. The roller may pick-up the additive liquid from the supply 252. In some embodiments, the roller may be a grooved roller or a metered roller (e.g., that is designed to apply a specific amount of additive liquid per rotation). As another example, the additive liquid may be applied via a steam application, such that it may be applied in a gaseous state that then forms into a liquid when it interacts with the web.

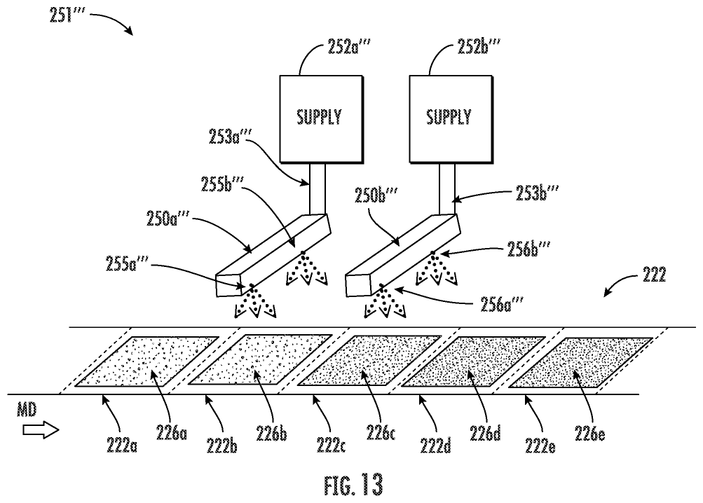

FIG. 13 shows another example additive application system 251″' includes two separate additive application devices 250a′″, 250b′″. The two separate additive application devices 250a′″, 250b′″ are positioned at different application sites along the web path for the first web 222 (e.g., the second additive application device 250b′″ is downstream of the first additive application device 250a′″). Each additive application device 250a′″, 250b′″ includes two spray devices 255a′″, 255b′″ and 256a′″, 256b′″, respectively, and is configured to mist additive liquid from separate supplies 252a′″, 252b′″ onto the first web 222 at different locations. In some embodiments, spacing apart the application of the additive liquid may enable variable application site placement (e.g., before and after the application of the expandable adhesive) and/or provide for increasing the amount of additive liquid applied to the first web without potential negative effects of introducing a larger quantity of additive liquid onto the first web all at once.

Further, additional functionality/optionality can be achieved. For example, in some embodiments, different compositions of additive liquid can be applied, such that each supply 252a′″, 252b′″ includes its own composition. Likewise, any of the embodiments contemplated herein may include multiple supplies that can be controlled for mixing and making various compositions as desired. Additional optional functionality includes the ability to only use one of the separate additive application devices 250a′″, 250b′″ so as to provide for customized application amount of the additive liquid.

### Example Flowchart(s)

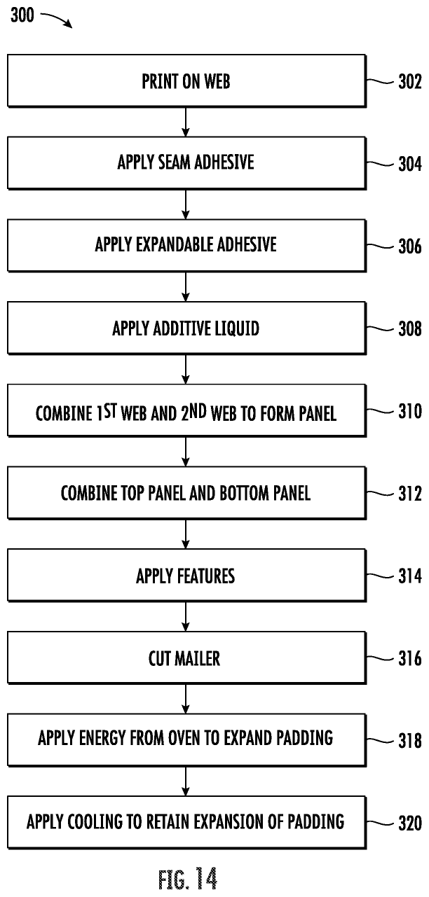

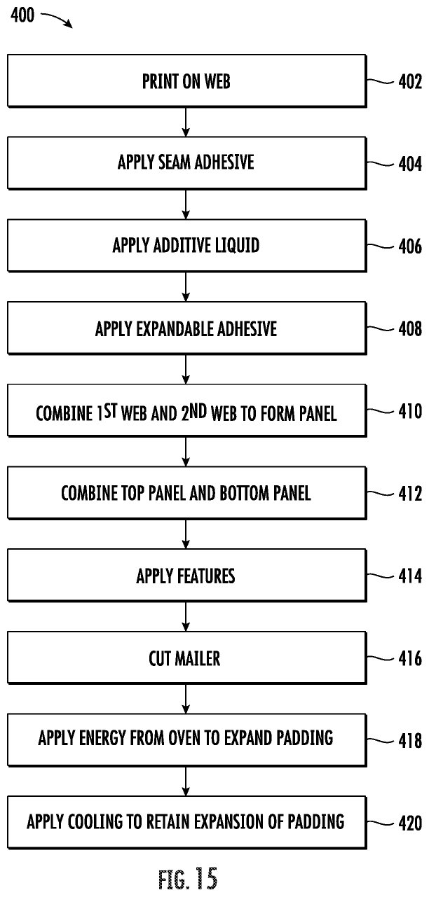

Embodiments of the present invention provide methods, apparatuses and computer program products for controlling the various components/features according to various systems described herein. Various examples of the operations performed in accordance with embodiments of the present invention will now be provided with reference to FIGS. 14-15.

FIG. 14 illustrates a flowchart according to an example method for forming a padded mailer according to an example embodiment. The operations illustrated in and described with respect to FIG. 14 may, for example, be performed by, with the assistance of, and/or under the control of one or more of the controller 190 and other components/features described herein, such as in the systems 100, 100′, 100″.

The method 300 may include printing on the first web at operation 302. At operation 304, the method may comprise applying the seam adhesive to the web, such as within the perimeter of the section of the first web.

At operation 306, the method comprises applying the expandable adhesive to the first web, such as within the internal area of the section of the first web. At operation 308, the method includes applying the additive liquid, such as described herein.

At operation 310, the first web and the second web are combined to form a panel of the padded mailer. Then, at operation 312, the panel is combined with a second panel to form the unexpanded padded mailer. At operation 314, various features may be applied to the unexpanded padded mailer. Then, at operation 316, the padded mailers may be separated, such as via one or more cutting operations. At operation 318, the oven may be operated to cause expansion of the expandable adhesive within the internal pouches of the padded mailer to form the padding therein. At operation 320, cooling may be applied to the expanded padded mailers to help retain a desired level of expansion.

FIG. 15 illustrates a flowchart according to another example method for forming a padded mailer according to an example embodiment. The operations illustrated in and described with respect to FIG. 15 may, for example, be performed by, with the assistance of, and/or under the control of one or more of the controller 190 and other components/features described herein, such as in the systems 100, 100′, 100″.

The method 400 may include printing on the first web at operation 402. At operation 404, the method may comprise applying the seam adhesive to the web, such as within the perimeter of the section of the first web.

At operation 406, the method includes applying the additive liquid, such as described herein. At operation 408, the method comprises applying the expandable adhesive to the first web, such as within the internal area of the section of the first web.

At operation 410, the first web and the second web are combined to form a panel of the padded mailer. Then, at operation 412, the panel is combined with a second panel to form the unexpanded padded mailer. At operation 414, various features may be applied to the unexpanded padded mailer. Then, at operation 416, the padded mailers may be separated, such as via one or more cutting operations. At operation 418, the oven may be operated to cause expansion of the expandable adhesive within the internal pouches of the padded mailer to form the padding therein. At operation 420, cooling may be applied to the expanded padded mailers to help retain a desired level of expansion.

FIGS. 14-15 illustrate flowcharts of various systems, methods, and computer program product according to various example embodiments described herein. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory and executed by, for example, the controller 190. As will be appreciated, any such computer program product may be loaded onto a computer or other programmable apparatus, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device to cause a series of operations to be performed on the computer or other programmable apparatus to produce a computer-implemented process such that the instructions which execute on the computer or other programmable apparatus implement the functions specified in the flowchart block(s).

### CONCLUSION

Many modifications and other embodiments of the inventions set forth herein may come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A system utilized in formation of a padded mailer, the system comprising:
an additive application system for applying an additive liquid to a portion of a first web, wherein a section of the first web that includes the portion of the first web and a section of a second web form a panel of the padded mailer,
wherein the section of the first web defines a perimeter and an internal area, wherein the portion of the first web to which the additive liquid was applied includes the internal area of the section of the first web, wherein the section of the second web defines a perimeter and an internal area, and
wherein, after the section of the first web and the section of the second web contact each other, the internal area of the section of the first web faces the internal area of the section of the second web to form an internal pouch, wherein, when the additive liquid and the expandable adhesive are energized via an oven, the expandable adhesive expands in thickness within the internal pouch to form padding for the panel of the padded mailer.

2. The system of claim 1, wherein the additive application system comprises at least one nozzle for spraying the additive liquid onto the portion of the first web.

3. The system of claim 2, wherein the additive application system comprises a reservoir for holding a supply of the additive liquid, wherein the reservoir is in fluid communication with the at least one nozzle.

4. The system of claim 2, wherein the at least one nozzle is configured to spray the additive liquid as a mist during application of the additive liquid onto the portion of the first web.

5. The system of claim 1, wherein the additive application system comprises a roller for contacting the portion of the first web to apply the additive liquid thereto.

6. The system of claim 1, wherein the additive liquid comprises water.

7. tem of claim 1, wherein the additive liquid is an aqueous solution.

8. The system of claim 1, wherein the additive liquid comprises a non-water additive.

9. The system of claim 1, wherein the additive application system is configured to apply an amount of additive liquid in a range of 0.001 g/in²-0.018 g/in² for the padded mailer.

10. The system of claim 9, wherein application of the amount of additive liquid in the range of 0.001 g/in²0.018 g/in² for the padded mailer enables (i) initial application of an amount of expandable adhesive in a range of 0.014 g/in²-0.030 g/in² for the padded mailer; and (ii) operation of one or more components of the oven at a desired speed to still cause expansion of the expandable adhesive such that a desired thickness of the padded mailer is in a range of 0.25-0.32 in.

11. The system of claim 1, wherein the additive application system is configured to apply the additive liquid onto the portion of the first web after the expandable adhesive has been applied to the internal area of the section of the first web or to the internal area of the section of the second web.

12. The system of claim 1, wherein the additive application system is configured to apply the additive liquid onto the portion of the first web before the expandable adhesive has been applied to the internal area of the section of the first web or to the internal area of the section of the second web.

13. The system of claim 1, wherein the additive application system is configured to apply the additive liquid onto the portion of the first web in conjunction with application of the expandable adhesive to the internal area of the section of the first web.

14. The system of claim 1, wherein the additive application system comprises a first application site along a web path for the first web and a second application site along the web path for the first web, wherein the second application site is downstream from the first application site along the web path.

15. The system of claim 14, wherein the additive application system is configured to:
apply a first additive liquid onto the portion of the first web at the first application site; and
apply a second additive liquid onto the portion of the first web at the second application site, wherein the first additive liquid comprises a different composition than the second additive liquid.

16. The system of claim 1, wherein the additive application system is configured to apply the additive liquid to the portion of the first web that includes the expandable adhesive.

17. A method comprising:
applying, via an additive application system, an additive liquid to a portion of a first web, wherein a section of the first web that includes the portion of the first web and a section of a second web form a panel of the padded mailer,
wherein the section of the first web defines a perimeter and an internal area, wherein the portion of the first web to which the additive liquid was applied includes the internal area of the section of the first web, wherein the section of the second web defines a perimeter and an internal area, and
wherein, after the section of the first web and the section of the second web contact each other, the internal area of the section of the first web faces the internal area of the section of the second web to form an internal pouch, wherein, when the additive liquid and the expandable adhesive are energized via an oven, the expandable adhesive expands in thickness within the internal pouch to form padding for the panel of the padded mailer.

18. The method of claim 17, wherein applying the additive liquid onto the portion of the first web occurs after the expandable adhesive has been applied to the internal area of the section of the first web or to the internal area of the section of the second web.

19. The method of claim 17, wherein applying the additive liquid onto the portion of the first web occurs before the expandable adhesive has been applied to the internal area of the section of the first web or to the internal area of the section of the second web.

20. The method of claim 17, wherein applying the additive liquid onto the portion of the first web occurs in conjunction with application of the expandable adhesive to the internal area of the section of the first web.

21. A system for forming a padded mailer, the system comprising:
a first web management device for controlling translation of a first web along a first web path;
a second web management device for controlling translation of a second web along a second web path;
a first adhesive application system for applying a first adhesive to at least a portion of a perimeter of a section of the first web that defines a bottom layer of a panel of the padded mailer, wherein the first adhesive is configured to adhere the perimeter of the section of the first web to a perimeter of a section of the second web that defines a top layer of the panel so as to form the panel, wherein the section of the first web further defines an internal area surrounded by the perimeter, wherein the section of the second web further defines an internal area surrounded by the perimeter;
a second adhesive application system for applying an expandable second adhesive to the internal area of the section of the first web;
an additive application system for applying an additive liquid to at least one of the internal area of the section of the first web or the internal area of the section of the second web prior to bringing the section of the first web and the section of the second web into contact with each other; and
an oven for providing energy, after the section of the first web and the section of the second web contact each other, to energize the additive liquid and the expandable second adhesive to cause the expandable second adhesive to expand in thickness to form padding for the panel of the padded mailer.

22. The system of claim 21, further comprising a cooling element for applying cooling to the padded mailer after the padded mailer passes through the oven so as to retain thickness expansion of the padding for the padded mailer.

23. A method of forming a padded mailer, the method comprising:
applying, via a first adhesive application system, a first adhesive to at least a portion of a perimeter of a section of a first web that defines a bottom layer of a panel of the padded mailer, wherein the first adhesive is configured to adhere the perimeter of the section of the first web to a perimeter of a section of a second web that defines a top layer of the panel so as to form the panel, wherein the section of the first web further defines an internal area surrounded by the perimeter, wherein the section of the second web further defines an internal area surrounded by the perimeter;
applying, via a second adhesive application system, an expandable second adhesive to the internal area of the section of the first web;
applying, via an additive application system, an additive liquid to at least one of the internal area of the section of the first web or the internal area of the section of the second web prior to bringing the section of the first web and the section of the second web into contact with each other; and
operating an oven to provide energy, after the section of the first web and the section of the second web contact each other, to energize the additive liquid and the expandable second adhesive to cause the expandable second adhesive to expand in thickness to form padding for the panel of the padded mailer.

24. The method of claim 23, further comprising operating a cooling element to apply cooling to the padded mailer after the padded mailer passes through the oven so as to retain thickness expansion of the padding for the padded mailer.
